(19) United States
(12) Patent Application Publication
(10) Pub. No.: US 2008/0040259 A1
(43) Pub. Date: Feb. 14, 2008

(54) Systems, Methods and Computer-Readable Media for Automated Loan Processing

(75) Inventors: Von Jackson Snow, Mocksville, NC (US); Kenneth Ray Carter, Advance, NC (US); Carl Woodrow Moser, Advance, NC (US)

Correspondence Address: DUANE MORRIS LLP, 1667 K. STREET, N.W., SUITE 700, WASHINGTON, DC, 20006-1608, US

(73) Assignee: SHEFFIELD FINANCIAL LLC, Clemmons, NC (US)

(21) Appl. No.: 11/680,935

(22) Filed: Mar. 1, 2007

Related U.S. Application Data
(60) Provisional application No. 60/778,185, filed on Mar. 1, 2006.

(51) Int. Cl. G06Q 40/00

(52) U.S. Cl. 705/38

(57) ABSTRACT

Systems, methods, and computer-readable media are described for providing an automated loan application. A method for providing an automated loan application may include scanning an applicant's identification card, extracting applicant identity data from the identification card, and receiving additional data, wherein the additional data comprise an amount of money to be borrowed. The applicant identity data and the additional data may be transmitted to a financial institution, which may determine whether to lend an amount of money to the applicant based at least in part on the identity data and the additional data. The applicant may then be notified whether the financial institution will lend money to the applicant.

### CROSS-REFERENCE TO RELATED APPLICATIONS

This application claims priority to U.S. Provisional Application No. 60/778,184, filed Mar. 1, 2006, entitled “Systems, Methods and Computer-Readable Media for Automated Loan Processing”, the entirety of which is incorporated herein by reference.

### FIELD OF THE INVENTION

The present invention generally relates to loan processing. The present invention more particularly relates to automated loan processing.

### BACKGROUND

Applications are commonly used for securing loans from a financial institution, such as a bank. A conventional loan application may comprise a paper form with fields for providing information relating to the applicant such as the applicant's name, address, income level, credit history and amount of the desired loan. An applicant may fill out the loan application at home, at a bank, or at another location where the borrowed funds may be used, such as a car dealership.

Once the loan application has been completed, it may be transmitted to a bank for review. Such transmission may occur by mail, by facsimile, or by hand delivery. Once the application has been received by the bank, the bank may process the loan by copying data from the loan application onto other forms for performing analysis of the applicant's risk level. The bank may use the other forms for performing credit checks, reviewing loan histories, or analyzing the applicant's debt level.

Once the bank has gathered information relating to the proposed loan, the bank analyzes the data and loan application and decides whether to approve the loan, deny the loan, request additional information, or require additional conditions from the applicant before approving or denying the loan. Once the bank has made a decision regarding the approval status of the loan, the bank will notify the applicant of its decision. If the loan is approved, the bank will then disburse funds to the dealer or seller of the goods to be purchased with the disbursed funds. If the loan is denied, the bank will take no further action.

Conventional loan application processing can have a number of disadvantages in their processes and methods. A conventional loan application may be disadvantageous because it may take an applicant a long time to complete. Further, because a conventional loan application might be handled and reviewed by many different people, human error can sometimes slow down the application process. For example, a person handling the loan may erroneously transcribe data from the original loan application into other forms during the application process. If, for example, an incorrect social security number is provided, a bank may inadvertently check the credit of the wrong person, or the bank may receive incorrect information relating to the applicant's financial status, increasing the time require to process the loan application or resulting in a decision being made using inaccurate data.

A further disadvantage of conventional loan application processing may be vulnerability to identity theft. Verification of an applicant's identity may be made by one or more factors including, what the applicant has in his or her possession (such as a driver's license), what an applicant knows (such as a social security number), and characteristics of the applicant himself or herself (such as fingerprints). Loan application processing methods and systems that verify an applicant based on only one factor may be vulnerable to an applicant who submits a fraudulent application based on another person's identity.

### SUMMARY

One embodiment of a method for automated loan processing comprises scanning an applicant's identification card, extracting applicant identity data, receiving additional data, wherein the additional data comprises an amount of money to be borrowed, transmitting the applicant identity data and the additional data to a financial institution, determining whether to lend the amount of money to the applicant based at least in part on the identity data and the additional data, and notifying the applicant of whether the financial institution will lend money to the applicant.. For example, scanning the identification card may comprise scanning an image of the face of a driver's license with a scanning device into a memory location on a computer. Data may then be extracted from the image by computer software capable of recognizing text within an image. The data may then be used to populate fields in the loan application. The applicant may then supply data to complete the remaining fields. A financial institution may then determine whether to approve the loan.

The method may further comprise providing a disclosure statement and receiving an acceptance of the disclosure statement from the applicant. For example, after the additional data is received, the applicant may agree to a disclosure statement provided by the computer. A financial institution may then determine whether to approve the loan.

Another embodiment of a method for automated loan processing comprises scanning an applicant's driver's license, storing data comprising applicant identity data from the applicant's driver's license, identifying at least one information field within the stored data, and recognizing at least one piece of identity data from the at least one information field using optical character recognition. Additional data may be received from the application comprising an amount of money to be borrowed, a disclosure statement may be displayed, and an acceptance of the disclosure statement may be received. At least a portion of the stored data, the identity data, and the additional data may be encrypted, and the encrypted data may be transmitted to a financial institution. The encrypted data may be decrypted, a determination may be made as to whether to lend the amount of money to the applicant, and the applicant may be notified of the determination.

These illustrative embodiments are mentioned not to limit or define the invention, but to provide examples to aid understanding thereof. Illustrative embodiments are discussed in the Detailed Description, and further description of the invention is provided there. Advantages offered by various embodiments of this invention may be further understood by examining this specification.

### BRIEF DESCRIPTION OF THE DRAWINGS

These and other features, aspects, and advantages of the present invention are better understood when the following Detailed Description is read with reference to the accompanying drawings, wherein:

FIG. 1 is a block diagram illustrating a system for automated loan processing in one embodiment of the present invention;

FIG. 2 is a flowchart illustrating a method for evaluating a loan application in one embodiment of the present invention.

FIG. 3 is a flowchart illustrating a method for automated loan processing in one embodiment of the present invention;

FIG. 4 is a flowchart illustrating a method for evaluating a loan application in one embodiment of the present invention;

FIG. 5 is a block diagram illustrating a system for automated loan processing in one embodiments of the present invention;

FIG. 6 is a block diagram illustrating a system for automated loan processing in one embodiment of the present invention;

FIG. 7 is a screenshot of a sample user interface for automated loan processing in one embodiment of the present invention;

FIG. 8 is a screenshot of a sample configuration window for automated loan processing in one embodiment of the present invention; and

### DETAILED DESCRIPTION

Various embodiments of the present invention provide systems, methods and computer readable media for automated loan processing.

One illustrative embodiment of a system of the present invention can comprise a scanner configured to scan the face of a driver's license, a computer in communication with the scanner, a user interface on the computer configured to receive input from an applicant, and a server remote from the computer and in communication with the computer.

Using this illustrative embodiment of such a loan processing system, an applicant may apply for a loan by inserting his or her driver's license into a scanning device, entering at least one more piece of data, agreeing to a disclosure statement, and transmitting the loan application to a financial institution.

In one embodiment, the scanner scans the face of the driver's license and transmits the scanned data to the computer. The computer receives the scanned data and extracts personal data from the scanned data. In an embodiment, the computer may extract the personal data using optical character recognition (“OCR”). The computer can then associate the personal data with fields in a computerized loan application in some embodiments. In some embodiments, the computer may associate the personal data with fields based at least on the format of the personal data. For example, the computer may recognize “9/28/52” as a date of birth based on the arrangement of numbers and “/” characters. In some embodiments, the computer may associate the personal data based on information scanned along with personal data, such as associating “9/28/52” with a “date of birth” field in a computerized loan application based on the characters “DOB” scanned from the face of the license. In some embodiments, the computer may associate the personal data based on the location of the data within the driver's license image. Other methods or techniques for associating the personal data known to those of skill in the art may be used as well.

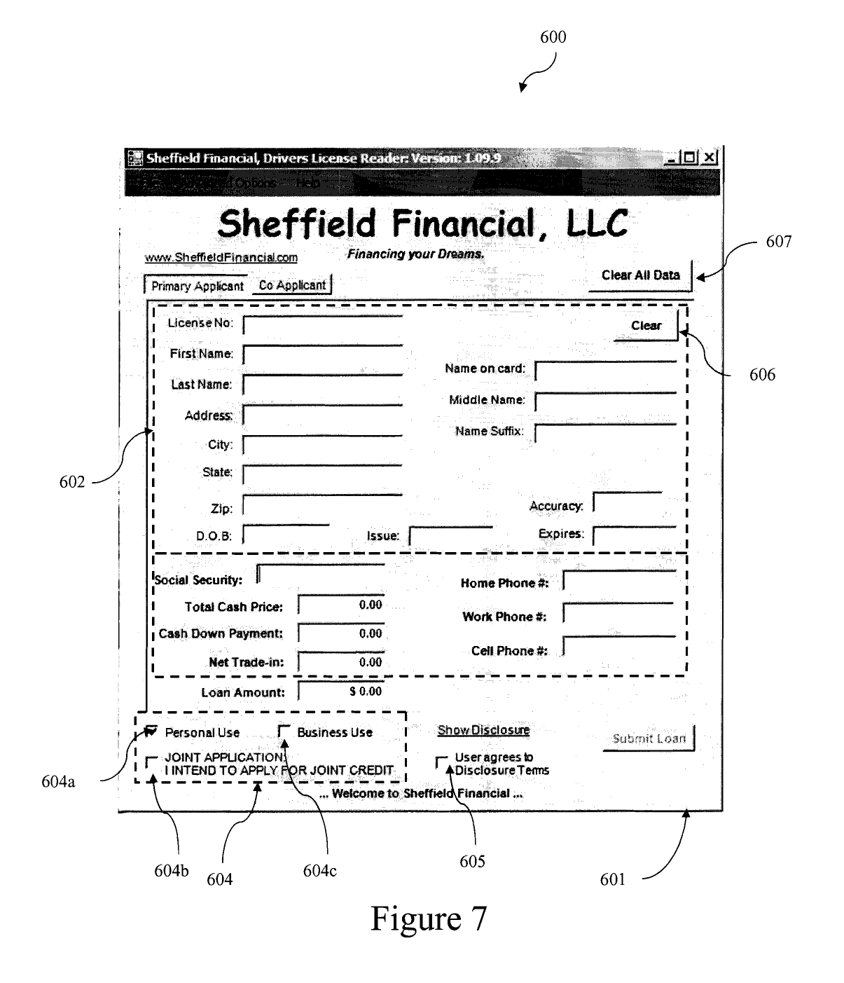

After associating the data, the computer displays a user interface screen comprising empty data fields and a submit button in one embodiment of the present invention. FIG. 7 and its accompanying description presents a more detailed description of one example of a user interface. Some of the data fields may contain data that have been recognized from the driver's license. In some embodiments, the computer can receive additional data corresponding to other data fields from an attached keyboard. For example, the computer may receive data corresponding to a loan amount, a home telephone number of an applicant, a work telephone number, a down payment, a purchase amount and/or a social security number of the applicant. Depending on the application and/or a lending institution's requirements, a variety of information can be required to complete the loan application.

Once the appropriate data fields have been completed, the computer 101 can display text, such as terms and/or conditions, along with an accept button to accept the terms or conditions that may be present within the text. For example, the computer may display a window entitled “Representations, Disclosures and Agreement” comprising terms or conditions. In some embodiments, the computer 101 can display a popup window comprising one or more terms, conditions, or notices. In other embodiments, the computer 101 can display the one or more terms, conditions, or notices to the applicant without the use of a popup window. If the accept button is pressed, the application data and the driver's license image can be encrypted and transmitted to the server 103 to be processed. In addition, the computer 101 may also display a reject button. If the reject button is pressed, the computer 101 may cancel the loan application.

In some embodiments, additional data may be received, such data may comprise data associated with a second person on the same computerized loan application, such as a co-signer or guarantor, and may comprise the second person's social security number, address, and phone number. For example, an embodiment of the present invention may allow a second individual to scan a driver's license for use within the loan application. A second individual may, for example, be required to co-sign or guarantee the loan for the first individual. In other embodiments, the loan may be a joint loan such that the second individual is also applying for the loan.

After the application data has been received by the server, the server may decrypt the application data and store the data in a database, in some embodiments. A new data file may be created that is easily viewable and understandable by a person, for example a loan officer, in some embodiments. A credit score may then be requested from a credit bureau. If the credit score is greater than an upper threshold, the loan application may be approved. If the credit score is less than a lower threshold, the loan application may be rejected in some embodiments. If the credit score is greater than the lower threshold and less than the upper threshold, the loan application may be examined further, or more data may be requested from the applicant in some embodiments.

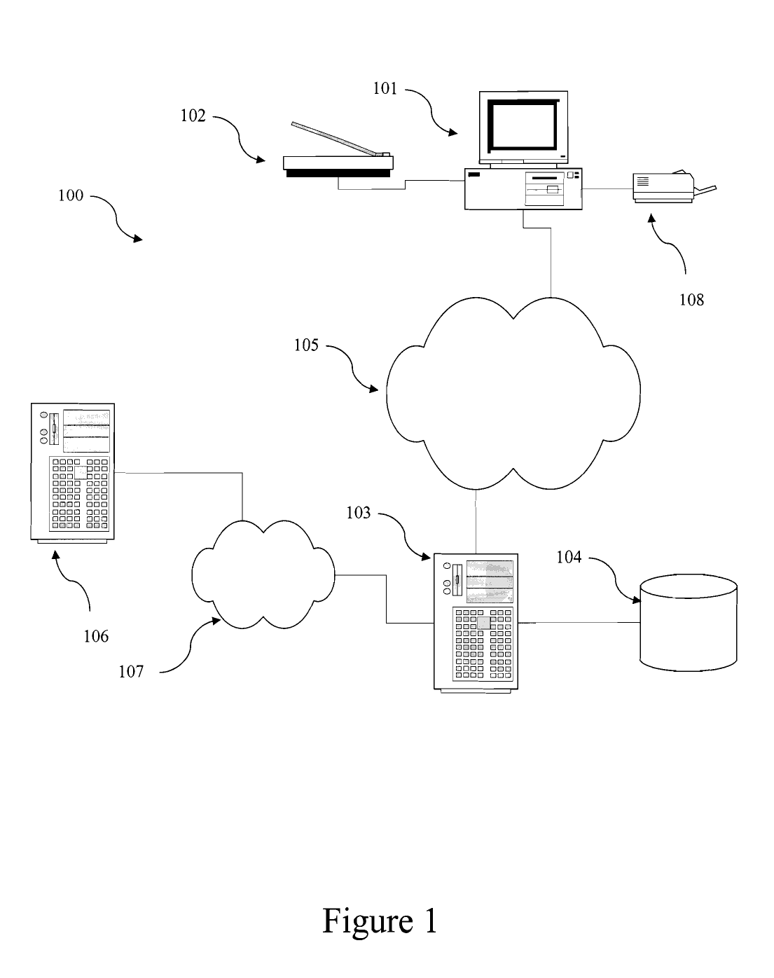

Referring now to the drawings in which like numerals indicate like elements throughout the several Figures, FIG. 1 is a block diagram illustrating a system for automated loan processing according to one embodiment of the present invention.

In the embodiment shown in FIG. 1, the automated loan application system 100 comprises a computer 101, a scanner 102, a printer 108, a server 103, a database 104, a network 105 connecting the computer 101 and the server 103, a credit bureau server 106, and a network 107 connecting the server 103 and the credit bureau server 106. The computer 101 is in communication with a scanner 102. The computer 101 is also in communication with the server 103 through the network 105. The computer 101 may comprise any type of computer including, but not limited to, a desktop computer, a laptop computer, a tablet computer (PC), a server, a personal digital assistant (PDA), or a computer specialized for automated loan processing. In some embodiments, the network 105 may comprise the computer 101 and the server 103 in communication using Ethernet, 802.11 wireless Ethernet, cellular telephone or data service (for example, GSM, GPRS, CDMA, WCDMA, 3G, UMTS, and others), Bluetooth, USB, FireWire, fiber optics, satellite transmission, or other methods. In some embodiments, the network 105 may comprise a local area network (LAN). In some embodiments, the network 105 may comprise a wide area network (WAN). In some embodiments, the network 105 may comprise the Internet. In other embodiments, a single computer may comprise both the computer 101 and the server 103, wherein the network 105 may comprise system, data, or memory buses located within the single computer.

In the embodiment shown in FIG. 1, the computer 101 is configured to control the scanner 102. For example, the computer 101 may be capable of powering the scanner 102 on and off. The computer 101 may also be configured to activate the scanner 102 to scan a driver's license, or to deactivate the scanner 102 once the driver's license has been scanned. The computer 101 may also be configured to respond to error messages from the scanner 102.

In some embodiments, scanner 102 may be incorporated into computer 101. For example, in one embodiment, a computer may have a scanner built into the case of the computer to form an integral unit. In one embodiment, a personal digital assistant may have a scanner built in to provide scanning capabilities without a separate scanner device. Using such an embodiment, a sales representative may be able to employ the personal digital assistant to scan a customer's identification card while on a showroom floor without having to return to an office.

The computer 101 shown in FIG. 1 is also configured to receive data from the scanner 102. The data received from the scanner 102 may comprise data relating to the status of the scanner 102, such as whether the scanner 102 is ready to scan, whether the scanner 102 is scanning a driver's license, whether the scanner 102 has scanned the entire driver's license, or other information relating to the operation or status of the scanner 102. The data received from the scanner 102 may also be data relating to a scanned image of a driver's license, a social security card, a loan application, or other document or object that the scanner is configured to scan.

In the embodiment shown in FIG. 1, the computer 101 is configured to process data received from the scanner 102. For example, the computer 101 is configured to save the scanned data to memory and recognize scanned data. In the embodiment shown, the computer 101 is configured to recognize the scanned data using OCR. In other embodiments, the computer is not configured to recognize the scanned data. The computer 101, in the embodiment shown, is also configured to store the recognized data in a different memory, or different area of the same memory, for example, within fields of a computerized loan application.

In one embodiment, the computer 101 is not configured to process data from the scanner 102. For example, in one embodiment, the computer may be configured to transmit data from the scanner to a remote computer, such as a central server. In such embodiments, an inexpensive computer, such as a thin-client, may be used to provide basic functionality such as data entry and submission of a loan application, but may not be configured to perform a more computationally strenuous process, such as analyzing data from the scanner. In some embodiments, a computer may be configured with a scanner, but not with any program code to perform any analysis of the scanned data. For example, a user may scan an image of an identification card and store the image on the computer. The computer may access a website on a remote computer, on which is an application for a loan. The user may transmit the stored image to the remote computer. The remote computer may then analyze the stored image and populate one or more fields in a web-based application form.

The computer 101 is further configured to display data on a display device and receive additional data from an input device in the embodiment shown. In some embodiments, the computer 101 may be configured to receive additional data from a keyboard or a mouse. In some embodiments, the computer 101 may be configured to receive additional data from another computer in communication with the computer 101, for example, from another computer that has access to data files comprising personal information about the applicant. In some embodiments, the additional data may comprise a social security number, a telephone number, an address, or a loan amount. In some embodiments, the additional data may comprise an indication of acceptance or rejection of a proposed agreement, disclosure statement, or proposed transaction.

In some embodiments, the computer 101 can be configured to encrypt data. In embodiments utilizing encryption, the computer 101 can be configured to encrypt data using secure hypertext transfer protocol (HTTP). In other embodiments, the computer 101 can be configured to encrypt the data using other algorithms including, but not limited to, secure file transfer protocol (FTP), private key encryption, or public key encryption.

In the embodiment shown in FIG. 1, the computer 101 is configured to transmit data to the server 103. In the embodiment shown, the computer 101 is configured to transmit data representing a loan application to the server 103. In some embodiments, the computer 101 can also be configured to transmit the driver's license image data to the server 103, either separately or with the loan application.

In some embodiments, the computer 101 is configured to receive data from the server 103. In some embodiments the computer 101 may receive data indicating an approval or denial of a loan application. In some embodiments, the computer 101 may receive data indicating additional information is needed and instructing the computer 101 to request additional information from the applicant.

The scanner 102 shown in the embodiment of the present invention shown in FIG. 1 is configured to scan a driver's license. In the embodiment shown, the scanner 102 comprises a flatbed scanner. In other embodiments, the scanner 102 may comprise a card reader. Examples of card readers that can be used as a scanner 102, in some embodiments, include, without limitation, a Scan Shell 800 card reader or Scan Shell 2000R card reader, each of which are sold by Card Scanning Solutions. Such scanners can be shipped with software that can assist in recognizing data from scanned driver's license images. Persons of ordinary skill in the art can identify other scanners, including card readers, for incorporating into various embodiments of the present invention.

In other embodiments, the scanner 102 may comprise a hand-held scanner. In some embodiments, the scanner 102 may be configured to scan other documents or objects including, but not limited to a social security card, a loan application, a credit report, a sales agreement, or other types of cards and documents.

For example in one embodiment, the scanner 102 may be configured to scan a loan agreement. In such an embodiment, an applicant may apply for a loan and be approved. The applicant may then print the loan agreement using the printer 108, sign the loan agreement, and scan the signed loan agreement. The computer 101 may then transmit the image of the signed loan agreement to the financial institution. In such an embodiment, an applicant may perform the entire loan process using the embodiment of the invention.

In the embodiment shown, the scanner 102 can be further configured to transmit data to the computer 101 including, but not limited to, scanner status and scanned data in this embodiment. In some embodiments, the scanner may have software configured to scan an image and perform OCR on the image. In some embodiments, software to scan an image, or to perform OCR, or both may not be included with the scanner, but such software may comprise software written by a programmer to facilitate scanning and OCR. In some embodiments, the scanner 102 may be configured to transmit status data including, but not limited to, power status, ready status, scanning status, or error status to indicate the status of the scanner. In some embodiments, the scanner 102 may be configured to transmit data relating to documents or objects that have been scanned including, but not limited to, size of the document or object scanned, color data, text data, number of data lines scanned, and the width of the data lines scanned.

In one embodiment, scanner 102 may not initially be in communication with computer 101. In such an embodiment, scanner 102 may comprise program code which may be installed on the computer 101 when scanner 102 is put in communication with computer 101. For example, scanner 102 may comprise program code for scanning an applicant's identification card, extracting applicant identity data from the identification card, receiving additional data, wherein the additional data comprise an amount of money to be borrowed, transmitting the applicant identity data and the additional data to a financial institution. Such program code may be installed automatically when the scanner is connected to computer 101, or a user of computer 101 may manually initiate the installation of the program code. Any program code within the scope of any embodiment of the present invention may be stored within scanner 102 and installed onto a computer 101 after scanner 102 comprising the program code is connected to the computer 101. Thus, it may be possible to distribute a scanner with program code for an embodiment of the present invention to a user having a standard computer, and install the program code on the computer to allow the user to apply for a loan according to one or more embodiments of the present invention.

In one embodiment, scanner 102 may not be in communication with a computer 101. In such an embodiment, scanner 102 may be configured to connect to network or other means of communication for communicating with a financial institution. The scanner may comprise program code for scanning a driver's license, populating the fields of an application based on scanned driver's license data, and transmitting the application to a financial institution without needing to connect with computer 101. For example, the scanner may comprise buttons, such as a number pad, for entering an amount of the loan, a social security number, a telephone number or other additional information. The scanner may also comprise a display, such as an LED or LCD display for requesting additional data. Such an embodiment may be advantageously employed to quickly generate and transmit a loan application without needing a more expensive computer to request additional information.

In the embodiment shown in FIG. 1, the server 103 is in communication with the computer 101 through a network 105, and with a database 104. The server 103 is configured to receive data from the computer 101, to transmit data to the computer 101, to transmit data to the database 104, and to receive data from the database 104. In the embodiment shown, the server 103 can receive data from the computer 101 associated with a loan application. The server 103, for example, can receive the loan application itself or the data fields requested to be completed with the application. The server 103, in the embodiment shown, can also be configured to receive data from the computer 101, such as a scanned image of an applicant's driver's license. The server 103 can be configured to store data as it is received from the computer 101 in a special location in memory in this embodiment. The server 103 can be further configured in some embodiments to periodically scan the special location in memory for new data to process. For example, a special location in memory may be configured as a location in which data relating to loan applications received from the computer 101 is stored, which may then be periodically scanned to retrieve new loan application data.

In embodiments where the data received by the server 103 is encrypted, the server 103 can be configured to decrypt data received from the computer 101. The server 103, for example, can be configured to decrypt the received data by using secure HTTP in some embodiments. In other embodiments, the server 103 may be configured to decrypt data using secure FTP, private key decryption, or public key decryption. The server 103 can be configured to use the method of decryption corresponding to the method of encryption used by the computer 101.

In one embodiment, a computer may allow a user to access an electronic loan application on a web-page. In such a web-based system, a computer may connect to a webpage stored on a remote computer or server. In such an embodiment, data transmitted to the webpage may be encrypted. For example, in one embodiment, a computer in a web-based system may employ a secure-socket layer (SSL) protocol to encrypt data transmitted between the computer and the web page. In one embodiment, a computer in a web-based system may employ asymmetric public key encryption, such as PGP encryption. In one embodiment, a remote computer or server may transmit encrypted information to a computer as a part of a web-based system.

In one embodiment, a thin-client may connect with a central server through a network. In such an embodiment, the thin client may receive scanned data from a scanner and transmit the scanned data to the central server over an encrypted local area network. In one embodiment, the thin client may employ SSL to encrypt data transmitted to the central server. In one embodiment, the thin client may receive encrypted data from the central server. For example, the thin client may receive data associated with the scanned data, such as a name, address, or other data.

In some embodiments, it may be advantageous to store some or all of the received data in a new file. For example, it may be advantageous to create a file based at least in part on the received data, wherein the new file is configured to be easily viewed by an employee of a financial institution, or wherein the new file is configured to be easily stored within a database at a financial institution. The server 103 can be configured to generate a new file in a different format, such as a hypertext markup language (HTML) file, based at least in part on the received scanned data and the received loan application. In some embodiments, the server 103 may be configured to generate an HTML file based at least in part on the received loan application. In other embodiments, the server 103 may be configured to generate an HTML file based at least in part on the received scanned data. In some embodiments, the server 103 may not be configured to generate an HTML file. In some embodiments, the server 103 may be configured to generate a non-HTML file based at least in part on data received from the computer 101. In some embodiments the scanned data may not be modified by the server 103.

In one embodiment, a server may receive data from the computer 102 and may identify the data based on a marker within the data. For example, in one embodiment, a server may identify data as being associated with scanned data, such as a scanned image of an identification card, based on a marker within the scanned data. In one embodiment, a marker may comprise one or more bytes of data within the scanned data identifying the scanned data as being an image of an identification card. In one embodiment, a marker may comprise one or more bytes of data within the scanned data identifying the data as a scanned contract, such as an executed loan agreement.

In some embodiments where the server 103 generates a new file,, the server 103 can be further configured to generate a file having a different format based at least in part on the first file generated. For example, if the server creates an HTML file based at least in part on the received scanned data, the server can generate a tagged image file format (TIFF) file based at least in part on the HTML file. Such an embodiment may be advantageous because it may allow embodiments of the present invention to easily integrate into an existing loan processing system at a financial institution. In other embodiments, the server 103 may be configured to generate an image file of a different format based at least in part on the data received from the computer 101. The image file may comprise any format of image file including, but not limited to, a joint photographic experts group (JPEG) file format, a graphics interchange format (GIF) file format, a targa (TGA) file format, a bitmapped (BMP) file format, or a proprietary image file format. In some embodiments, the server 103 may be configured to not generate an image file.

In the embodiment shown, the server 103 is configured to store the data received from the computer 101 and any or all files created from the data to a database 104. In other embodiments, the server 103 can store a TIFF file, an HTML file or other files or file formats it receives or generates.

In the embodiment shown, the server 103 is in communication with a credit bureau server 106 through a network 107. The server 103 is configured to transmit a request for a credit report to the credit bureau server 106. The server 103 is further configured to receive data from the credit bureau server 106 including, but not limited to, a credit score or a credit report. In some embodiments, the server 103 is configured to receive data from credit bureaus well-known in the industry including, but not limited to, Equifax, Experian, Trans Union, or Dun & Bradstreet. In other embodiments, the server may not be configured to communicate with the credit bureau server 106 and a credit score or credit report may be obtained in another manner. For example, a loan officer can contact a credit bureau by phone, fax, email or other communication method and request a credit score or credit report.

In some embodiments, the server 103 may be configured to transmit data to the computer 101. The data can comprise, for example, updated data for the computer 101. Updated data may be provided for any number of reasons. For example, the data may comprise an updated loan application comprising new or different fields. For example, the data may comprise a loan application specifically suited for a loan to purchase a car, rather than a general purpose loan The data may comprise additional rules for determining whether an application is sufficiently complete. For example, the data may comprise new rules requiring the applicant to provide three telephone numbers, instead of two telephone numbers, before the application will be determined to be complete and ready for transmission to the server. The data may comprise information relating to special offers or rewards, such as rewards or offers targeted at the entity who is providing an embodiment of the present invention to be used by the entity's customers who may initiate loan applications. For example, a car dealership or car salesman may receive offers from the server providing incentives for encouraging the dealership's customers to apply for a loan using an embodiment of the present invention. In some embodiments, the data may comprise rewards or incentives for loan applicants. In some embodiments, the rewards or incentives may be viewable by selecting an appropriate button, menu or other element of the user interface. The data my comprise updates for the system, such as a new version of software for execution on the computer.

Some embodiments may provide ways to inform a dealer or applicant of incentives. For example, in one embodiment of the present invention, the computer may display, along with, for example, the user interface screen shown in FIG. 7, an additional window comprising an advertisement, or an offer for lower interest rates on a loan if the applicant is willing to open a checking account, or an incentive for the dealer to use a particular financial institution. In some embodiments, the incentives may be displayed alongside the user interface window. In some embodiments, the incentives may be displayed before the user interface window is displayed. In some embodiments, the incentives may be displayed before the applicant may submit the application.

In some embodiments of the present invention, the computer 101 may be configured to display advertisements on the screen and/or play audio advertisements. For example, in one embodiment of the present invention, the computer 101 may be configured to display one or more of the following: an advertising banner, an advertising streamer, or a popup window comprising an advertisement. In one embodiment of the present invention, the computer 101 may be in communication with speakers. In such an embodiment, the computer 101 may be configured to play an audio advertisement through the speakers. In one embodiment, the computer 101 may be configured to play an audio advertisement and display an advertisement on the screen. In one embodiment, the computer 101 may be configured to display an advertisement on the screen and play an audio advertisement, where the audio advertisement is related to the advertisement displayed on the screen.

Embodiments of the present invention can be advantageously located in a variety of settings. For example, an embodiment of the present invention can be located in a common area of a shopping mall, a car dealership, or other store or facility wherein it may be advantageous to have a convenient system for applying for a loan from a financial institution or other lender. For example, an embodiment of the present invention can comprise a kiosk. The computer 101 and scanner 102 can be located within the kiosk such that an applicant can enter the kiosk, scan his or her driver's license, input additional information, submit the application, and receive notification and/or disbursement of the loan.

In one embodiment of the present invention, the computer 101 may comprise a PDA in communication with a card reader. In one embodiment, the PDA may be configured to communicate with the network 103 using wireless communication, such as, for example and without limitation, wireless Ethernet (e.g. 802.11), a cellular network, or Bluetooth. Such an embodiment may be advantageously used by a seller of goods who may have a very large property, or may meet with a potential buyer at a location remote from the seller's office. Using such an embodiment, an applicant may be able to complete and submit a loan application by scanning his or her driver's license, using the card reader, into the PDA, completing the remaining fields of the application, agreeing to a disclosure statement, and submitting the application to a financial institution using a wireless communications device, such as those discussed above.

Embodiments of the present invention may also comprise systems configured to perform services for a dealer or store owner providing an embodiment for use by the dealer's or store owner's customers. One embodiment of the invention may be configured to generate a sales invoice based at least in part on the information scanned from an applicant's driver's license or information entered by the applicant. For example, one embodiment of the present invention may be capable of calculating sales tax, allowing a dealer to select additional fees, and creating a sales invoice based at least in part on the sales tax, the selected fees, and information entered by the applicant. An embodiment of the present invention may be configured to generate sales reports based at least in part on data entered by one or more applicants. An embodiment of the present invention may be configured to allow a dealer or storeowner to create or maintain a mailing list based at least in part on information scanned from one or more applicants' driver's licenses.

One embodiment of the present invention may be configured to communicate with a bookkeeping system of a dealer or store owner providing the embodiment of the present invention. For example, if an item is purchased with funds from a loan acquired using the embodiment of the present invention, the embodiment may generate a sales record and automatically add the sales record to the dealers bookkeeping system. For example, in one embodiment, a sales dealer may use QuickBooks™. If a customer purchases an item using with proceeds from a loan acquired using an embodiment of the present, the embodiment may communicate with QuickBooks to indicate the sale of the item, a sale price of the item, a reduction in inventory, taxes paid by the purchaser, a commission rate for a salesman, a discount, and/or a rebate.

In one embodiment of the present invention, a system may communicate with a dealer computer system configured to generate messages, such as e-mails, to customers of the dealer. For example, if a customer purchases an item from the dealer, the embodiment of the present invention may communicate with the dealer computer system to indicate that a message should be sent to the customer in six months to remind the customer of maintenance. In one embodiment, the system may indicate to the dealer computer system that a maintenance message should be periodically sent to a customer, such as on a typical maintenance cycle. In one embodiment, the system may indicate to the dealer computer system that a message should be sent when a new model or version of the item is offered for sale.

Embodiments of the present invention may be advantageously configured to aid a financial institution with complying with local, state, or federal statutes. For example, one embodiment of the present invention can be used to ensure compliance with the Customer Identification Program requirements of the USA Patriot Act for opening new accounts.

Embodiments of the present invention may be configured to perform additional functions such as opening a new deposit account with a financial institution, or opening a new credit account with a financial institution, such as a new credit card account. Embodiments of the present invention may be advantageously used to provide remote conferencing with representatives of a financial institution. For example, a customer of a financial institution may use an embodiment of the present invention to engage in an audio/visual conference with a representative of the financial institution to discuss matters relating to the customer's accounts.

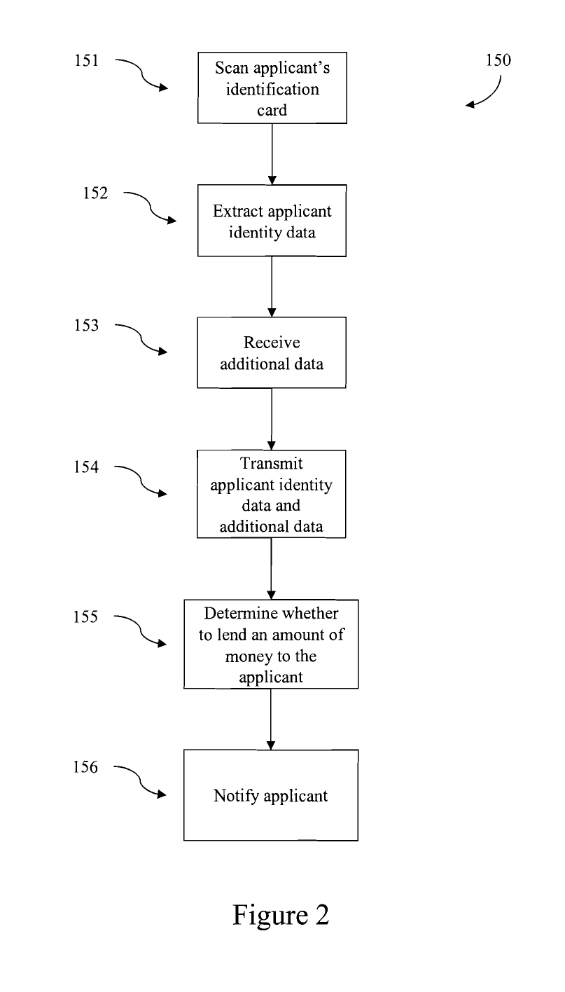

Referring now to FIG. 2 which is a flowchart illustrating a method 150 for automated loan processing according to one embodiment of the present invention. The method begins with scanning an applicant's identification card as shown in step 151. An identification card may comprise a driver's license, a passport, a military identification card, a government issued identification card, a school identification card, a social security card, or any other card or paper on which is imprinted information associated with the applicant, such as a name, address, telephone number, social security number, or other personal information. In one embodiment of the present invention, scanning may comprise inserting the identification card into a scanner, passing a scanner, such as a hand-held scanner, over the card, or using any other scanning device capable of reading data from the identification card.

After the identification card has been scanned, applicant identity data is extracted from the card in step 152. Data may be extracted through optical character recognition, image recognition, interpreting information on a magnetic stripe, one dimensional bar code, two dimensional bar code, or any other means for interpreting the scanned data. Applicant identity data may include an applicant's name, address, date of birth, driver's license number, passport number, identification number, expiration date of the identification card, or any other information associated with the applicant. In one embodiment, extracting applicant identity data may comprise identifying at least one information field on the identification card. For example, in one embodiment, specialized computer software may be used which has specific information associated with the location of information on driver's licenses from one or more states. In such an embodiment, the specialized software may identify that a scanned driver's license is a North Carolina driver's license, and may identify one or more information fields known to be on a North Carolina driver's license, and extract data from one or more of the information fields.

Additional data may be received in step 153, such as an amount of money to be borrowed. Other data may be received as well, such as a social security number, a telephone number, a type of loan (such as a personal loan or a commercial loan), an age, an income, information regarding collateral, or any other information. In one embodiment, the additional data may be received from the applicant. In one embodiment, the additional data may be received from a dealer, seller of products, or other person. In one embodiment, the additional data may be received from both the applicant and another person.

The applicant identity data and the additional data may be transmitted to a financial institution in step 154. The applicant identity data may be transmitted over a wide-area network (WAN) such as the Internet, over a local area network (LAN), a telephone line, through a wireless connection, or through any other means of data transmission. In one embodiment, a scanned image of the identification card may be transmitted to the financial institution. In one embodiment, the applicant identity data and the additional data may be encrypted before being transmitted to the financial institution.

Once the applicant identity data and the additional data have been transmitted, a determination of whether to lend the amount of money to the applicant may be made in step 155. In one embodiment, the determination is based at least in part on the identity data and the additional data. In one embodiment, the determination may also be made based at least in part on a credit score, a lending history, an amount of the loan, or a value of any collateral. In one embodiment, the financial institution determines whether to lend the amount of money to the applicant. In one embodiment, a third party may determine whether to lend the amount of money to the applicant.

Once the determination is made, the applicant may be notified of whether the financial institution will lend money to the applicant in step 156. The applicant may be notified with an e-mail, a telephone call, a facsimile, a pop-up message on a computer screen, or any other means by which the applicant may be notified.

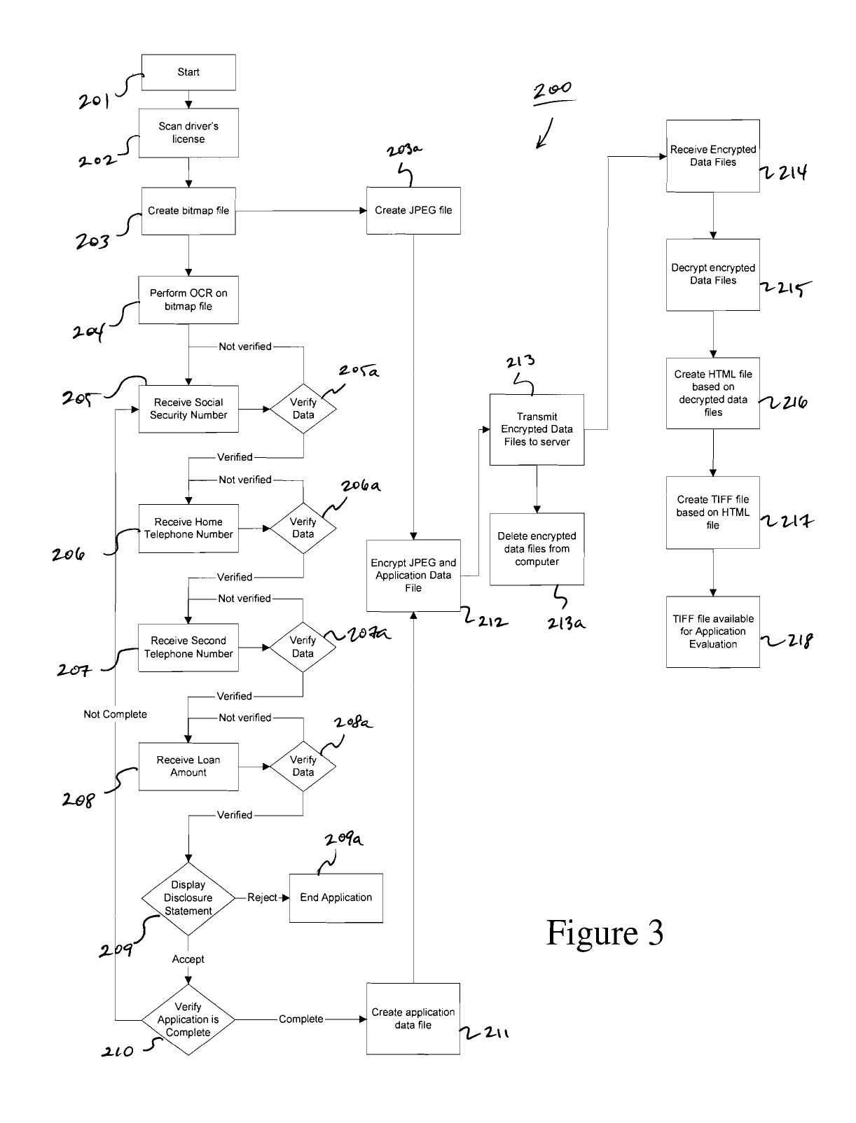

Referring now to FIG. 3, FIG. 3 is a flowchart illustrating a method 200 for automated loan processing according to one embodiment of the present invention. Other embodiments may comprise additional steps, or perform the steps of FIG. 3 in a different order; the ordering of the steps shown in FIG. 3 is not meant to be limiting.

In the embodiment of the present invention shown in FIG. 3, the method 200 begins 201 by scanning a driver's license 202. In the embodiment shown, the driver's license is scanned 202 with a card reader. The scanned driver's license data is stored as a BMP file 203. In other embodiments, the scanned data may be stored in other file formats, including, but not limited to, JPEG, TGA, TIFF, GIF, or a proprietary file format. In some embodiments, the scanned data may not be stored in a file at all. For example, the scanned data may be stored in volatile memory within the computer, such as the computer's RAM. The BMP file is then processed with OCR 204 to extract data to be used in the loan application. For example, in one embodiment, data including, but not limited to, a name, an address, or a date of birth may be extracted. The bitmap file is then converted into a JPEG image file 203a. In other embodiments, the bitmap file may be converted to other file formats including, but not limited to, a GIF file, a TGA file, or a TIFF file. In further embodiments, the BMP file may not be converted to a different file format or may not be converted at all. Factors that can be important in selecting a file format include, without limitation, file formats already supported by existing computer systems within the financial institution; size of generated files, or ease of generation of new files.

Once all of the driver's license data from the BMP file have been recognized, the system receives at least one piece of data from another source 205, 206, 207, 208. The at least one piece of data can comprise, for example, a social security number, a home telephone number, a business telephone number, a cellular telephone number, a loan amount, information relating to a co-signor or guarantor, and various combinations thereof. In addition, other data can also be received. The data need not be received in any particular order, though particular embodiments of the present invention may prompt for data in a particular sequence, while other embodiments may accept data in any sequence. The additional data can include, for example, data that are necessary to process a loan, but that might not be available on a driver's license.

As data is received 205, 206, 207, 208, data verification is performed 205a, 206a, 207a, 208a in this embodiment. Data verification 205a, 206a, 207a, 208a may be different for different types of information. For some types of data, no verification may be undertaken. The methods of data verification used within various embodiments of the present invention are for verifying that received data is in the proper form to be entered into a loan application, not for verifying the accuracy or correctness of the received data. For example, data verification for a social security number 205a may comprise the step of verifying that the received social security number has the correct number of digits. In another example, data verification for a received loan amount 208a may comprise the step of verifying that the loan amount is greater than $0, or another threshold. If the data is in the proper form, the method will continue to the next step. If the data is not in the proper format, in some embodiments of the present invention, a request for the data will be made again and the method will not proceed to the next step until the data is received in the proper format. In some embodiments of the present invention, an error message will be displayed or transmitted and the method will not proceed to the next step until the data is received in the proper format. Other embodiments may not perform data verification.

In other embodiments of the invention, additional steps for data authentication may be used. Such steps may be used to verify the accuracy, correctness or internal consistency of the received data. For example, in some embodiments of the present invention, a received social security number may be authenticated along with a received name to verify that the social security number corresponds to the received name. In some embodiments, other data may be authenticated including, but not limited to, telephone numbers, addresses, or employment information. In some embodiments, data can both be verified and authenticated. In some embodiments, data can be verified, but not authenticated. In some embodiments, data can be authenticated, but not verified.

Once an indication has been received that the application is complete, one or more statements may be displayed 209 or transmitted, in some embodiments. The statement can comprise disclosures, notices, or other information relating to the processing of the loan application. The statement may comprise statements that the information within the loan application may be used to perform one or more credit checks, or that the information will be kept confidential. The statements can comprise, for example, statements that are required by the federal or local governments in connection with such transactions. The statement can be a notification, such as a notification of rights, or a statement that the loan applicant agrees to the terms or statements displayed. For example, that statement can be an authorization for the loan processor to request a credit report on the applicant. Other statements or disclosures may be made as well.

Before the process may proceed in this embodiment, notification of acceptance of the statements or disclosures must be received from the applicant. For example, in one embodiment, the statements or disclosures may be displayed in a window on a computer screen, the window comprising at least two buttons: one to accept the statements or disclosures, and one to reject the statements or disclosures. If the button corresponding to an acceptance of the statements (the accept button) or disclosures is pressed or selected, the method continues to the next step. If the button corresponding to a rejection of the statements or disclosures is pressed or selected, the method will terminate 209a. In some embodiments, the accept button may be deactivated until the computer detects that the entire disclosure statement has been shown on the screen. For example, in one embodiment, a disclosure statement may comprise enough statements that all of the statements are not visible on the screen simultaneously. In such an embodiment, a scroll bar may be provided to allow an applicant to scroll through the statement, thereby enabling the applicant to view the entire disclosure statement. In such an embodiment, the accept button may be deactivated until the applicant has scrolled to the end of the disclosure statement, at which time the accept button will be activated. In another embodiment, the disclosure statement may comprise a plurality of statements, wherein each statement has a corresponding selectable element, such as a button or checkbox, that when selected, indicates that the corresponding statement has been read. An applicant may be required to select all of the selectable elements in order to activate the accept button. Such embodiments may be advantageous for the reason that they provide some incentive for an applicant to read each and every part of the disclosure statement. In some embodiments, the window may comprise only an accept button. In such an embodiment, for example, the applicant may be prevented from submitting the application until selecting the accept button.

Once the statements or disclosures have been accepted, the completeness of the application is verified 210 in the embodiment shown. The requirements for completeness, or the business rule requirements, of the application can vary among different embodiments of the present invention. For example, in the embodiment of the present invention shown in FIG. 3, the application will be complete if the following data fields are complete: the name, social security number, date of birth, home telephone number, home address, business telephone number, and loan amount. Other embodiments may comprise more, fewer and/or different data fields. For example, another embodiment may comprise one or more data fields corresponding to information about one or more additional applicants, co-signers, or guarantors of the loan. Other embodiments may comprise fewer data fields than are used in the embodiment shown in FIG. 3. For example, some embodiments of the present invention may only comprise data fields for a name, social security number and loan amount.

If the application is not complete, the missing data must be received before the method will continue in some embodiments. In some embodiments, the missing information may be specifically requested. In some embodiments, the empty data fields may be highlighted. Other methods of indicating missing data may be employed as well, such as prompts or audible signals.

Once the application is complete, an application data file comprising the application data is created 211 in this embodiment. The application data file and scanned driver's license image file are then encrypted 212, in this embodiment. In some embodiments, the two files are merged into a single file prior to encryption 212. For example, the two files may be compressed within a “ZIP” file prior to encryption 212. In other embodiments, the two files are separately encrypted. In some embodiments, the two files are entirely encrypted before transmission. For example, in some embodiments, the data within the two files is encrypted and stored in two new encrypted data files. In some embodiments, the two files are encrypted as they are sent and no encrypted files are created. For example, in some embodiments the files may be transmitted in many segments, such as in data packets sent over a network, wherein each data packet is separately encrypted before it is sent.

Some embodiments may not comprise steps or systems for encrypting or decrypting data. For example, an embodiment of the present invention may be located within an office of a financial institution and in direct communication with the financial institution's network. In such an embodiment, encryption and decryption may not be needed as there is less danger of the loan data and image data being intercepted.

In the embodiment shown, the application data file and the JPEG file are each encrypted 212 separately to create two new encrypted data files. The encrypted data files are then transmitted 213 to a server. In the embodiment shown, after the encrypted data files are transmitted, the encrypted data files are erased from the transmitting device 213a. In some embodiments, the encrypted data files can be stored in a computer memory or database.

In the embodiment of the invention shown in FIG. 3, the data files are received 214 and stored by a server. The data files are decrypted 215 by the server into unencrypted files in the embodiment shown. An HTML file is then created 216 based at least in part on the unencrypted data files. In other embodiments, a file of another format may be created based on the received, unencrypted files, such as an extensible markup language (XML) file, or a data file with a proprietary structure. Factors that can be important in selecting a file format include, without limitation, file formats already supported by existing computer systems within the financial institution; size of generated files, or ease of generation of new files.

In the embodiment of the present invention shown in FIG. 3, a TIFF image file is created 217 based at least in part on the HTML file. In other embodiments, an image file may be created using a different file format, such as BMP, GIF, TGA, or JPEG. In other embodiments, no image file may be created based on the HTML file.

Once the TIFF file has been created 217, the file is made available 218 for application evaluation 300. In some embodiments of the present invention, additional steps may be performed before or after the file is made available 218 to application evaluation 300. For example, in some embodiments, the encrypted and/or decrypted data files may be deleted before or after the TIFF file is made available 218 to application evaluation 300. In some embodiments, both the HTML file and the TIFF file may be made available 218 to application evaluation 300. In some embodiments, the HTML file and/or the TIFF file and/or the unencrypted data files and/or the encrypted data files may be stored in a database before or after the TIFF file is made available 218 to application evaluation 300. In some embodiments, an acknowledgment of receipt of the data files may be sent to the system that transmitted the data files to the server.

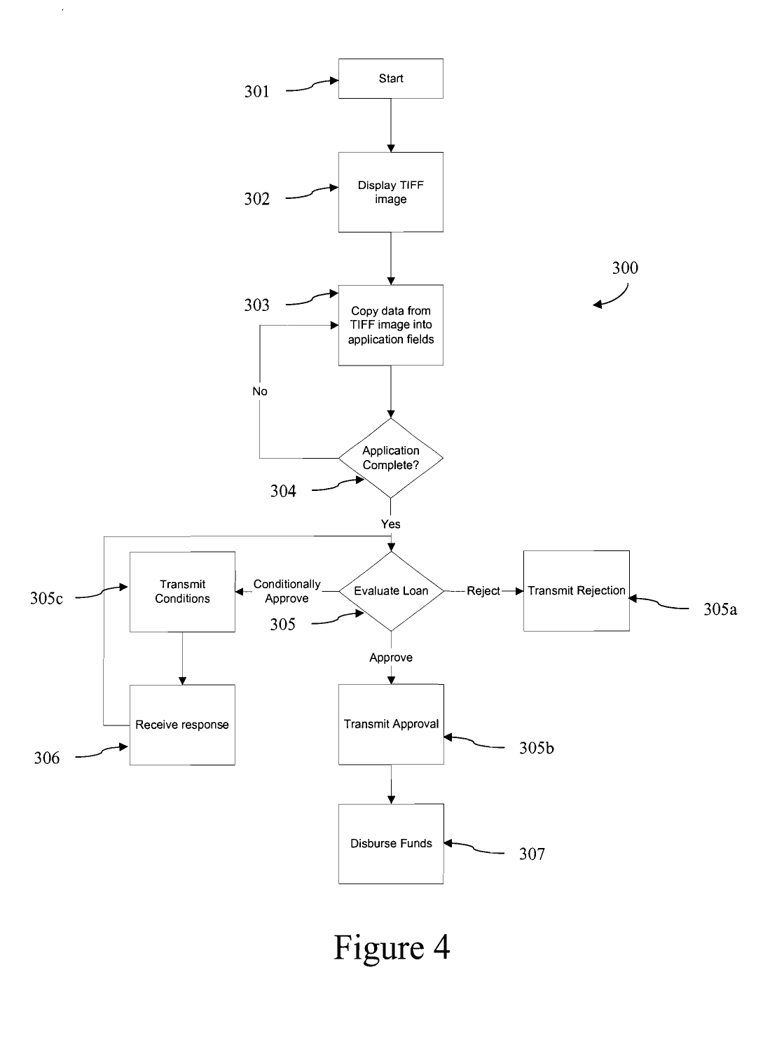

Referring now to FIG. 4, which is a flowchart illustrating a method for evaluating a loan application in one embodiment of the present invention. The method 300, in this embodiment, comprises the steps of displaying an image of the loan application, copying data from the displayed image into application fields, verifying that the application is complete, and deciding whether to approve or deny the loan, or request more information from the applicant. If the loan is approved, funds may be disbursed.

The method 300 begins 302 by displaying a TIFF image 302. The data from the TIFF image is then copied into application fields 303. In some embodiments, data from TIFF image can be copied into the application fields manually. In some embodiments, the data can be copied automatically. In other embodiments, the data can be copied manually onto a hard copy of the application. In other embodiments, the data can be copied into an electronic application form. In some embodiments, the TIFF image can not be displayed and the data may be copied directly from the unencrypted application data file into fields in a computerized loan application.

Once data from the TIFF file has been copied into application fields 303, the application is checked for completeness 304 in this embodiment. If the application is not complete, more data will need to be entered into the application fields 303. If the application is complete, the application may be evaluated 305. Some embodiments, certain data may be minimally required in order for the application to be complete.

The evaluation of the application can be based on a number of criteria, including without limitation, a credit report and/or a credit history of the applicant. In some embodiments, the application may be evaluated based on a credit score and a credit history. In other embodiments, an application may be evaluated based on other criteria present in the application, criteria supplied during the loan application process, or historical information about the applicant stored by the processor.

In one embodiment, an application may be evaluated by a person, such as a loan officer. For example, in an embodiment, a loan officer may view a loan application submitted by an applicant. The loan officer may then review one or more portions of the application and determine whether to approve or deny the loan. For example, a loan officer may review a loan application and determine whether a loan application should be initially recommended for approval or denial based upon a credit score, or whether the loan application should be reviewed more thoroughly for additional factors. In some embodiments, a loan officer or other bank employee may be involved in the loan application process. For example, in one embodiment, a bank employee may verify fields filled into a digital loan application against the scanned image of a driver's license to reduce the number of errors caused by a bad OCR interpretation of the image of the driver's license.

In one embodiment, an application may be evaluated automatically. For example, in one embodiment, an application may be automatically approved or denied based upon threshold credit score levels. In one embodiment, an application may be automatically approved or denied using one or more factors, including a credit score, a current debt load, a repayment history, an income level, marital status, or other factor(s). In one embodiment, an algorithm may provide a recommendation to approve or deny a loan to a bank employee or loan officer. In such an embodiment, a recommendation may provide improved response time for loan processing, while allowing a person to review such loans for errors or further processing.

In some embodiments, the computer 101 may be configured to receive information from a server. For example, in some embodiments, the computer 101 may be configured to receive information from the server 103 comprising a decision relating to the loan application. For example, after the loan application has been evaluated, a decision can be transmitted to the applicant. In some embodiments, the decision can be transmitted by telephone, by fax, by e-mail, or as a message sent from the server 103 to the computer 101 that may be displayed on the screen of the computer 101. In the embodiment shown, depending on the decision reached, the system can either transmit a rejection 305a, transmit an approval of the loan 305b, or transmit additional conditions 305c that must be satisfied.

In some embodiments, the computer 101 may be configured to receive requests for additional information to be used in evaluating the loan application. For example, the computer 101 may be configured to receive a request for additional information, display a window, receive input relating to the request, and transmit the data in response to the request. In some embodiments, the computer 101 may be configured to receive multiple requests for additional information.

If the loan is approved, funds may be disbursed to the applicant in the amount approved 307. In some embodiments, funds may be disbursed to the applicant with a check or a direct deposit of funds into an account held by the applicant. In some embodiments, funds may be disbursed to the dealer or seller of goods for which the loan was secured. In other embodiments, funds may be partially disbursed to the applicant and partially disbursed to the dealer or seller of goods.

In one embodiment, if the loan is approved, a loan agreement may be printed at the applicant's location. For example, a computer the applicant used to submit the loan application may be configured to print the loan agreement. In such an embodiment, the applicant may then review and sign the loan agreement. In one embodiment, after signing the loan agreement, the user may be able to scan the signed loan agreement using the scanner in communication with the computer. The computer may then transmit the signed loan agreement to the financial institution. In such an embodiment, the financial institution may be able to disburse funds to the applicant more quickly and with greater confidence because a signed copy of the loan agreement has been received. In one embodiment, the signed copy of the loan agreement may be physically transported to the financial institution. In one embodiment, the signed copy of the loan agreement may be both scanned and transmitted to the financial institution and physically transported to the financial institution.

In one embodiment, a computer may comprise a touch screen or tablet that may be configured to allow a user to electronically sign a loan application. For example, the computer may display an image of the loan application for the applicant to review. The applicant may cause the signature line of the loan application to be displayed. The applicant may then electronically sign the loan agreement using a touch screen and, for example, a stylus. The computer may then transmit the electronically-signed loan agreement to the financial institution.

If the loan is denied, no further action is taken. If the loan is conditionally approved, conditions are transmitted to the applicant 305c. The response to the transmitted conditions is then received 306, and the loan application is evaluated 305 again. The process of transmitting conditions 305c, receiving responses to the conditions 306, and evaluating the loan 305 may repeat until the loan application is approved, or until the loan application is denied.

In addition to the embodiments described above and shown in the several Figures, other embodiments are contemplated in providing systems, methods and computer-readable media for automated loan processing.

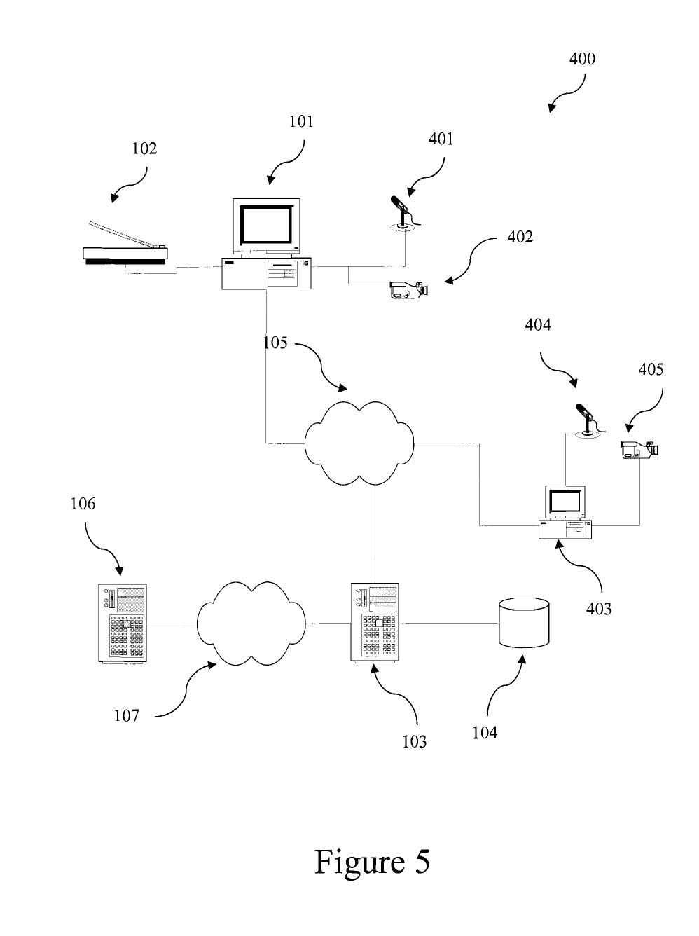

FIG. 5 illustrates another embodiment of the present invention, which is a variation on the embodiment shown in FIG. 1. As illustrated in FIG. 5, it may be advantageous if the system described in FIG. 1 further comprises a first camera 402 in communication with a first computer 101, a first microphone 401 in communication with the first computer 101, a second camera 405 in communication with a second computer 403, and a second microphone 404 in communication with the second computer 403. In the embodiment shown in FIG. 5, the first computer 101 is further configured to receive video data from the first camera 402 and audio data from the first microphone 401, and to transmit the video and audio data to the second computer 403. The first computer 101 is further configured to receive video and/or audio data from the second computer 403. The second computer 403 is configured to receive video data from the second camera 405 and audio data from the second microphone 404. The second computer 403 is further configured to transmit video data and audio data to the first computer 101. The second computer 403 is further configured to receive video data and audio data from the first computer 101. In some embodiments of the present invention, additional video and communication methods using techniques known to those skilled in the art can be used.

The use of video and/or audio data may be useful during the processing of an automated loan application for enabling direct communication between an applicant and a person employed by or working at the entity evaluating the loan application, such as a loan officer at a bank. For example, if the loan application is conditionally approved, the loan officer, using the second computer 403, may initiate a video and/or audio connection to the first computer 101, thereby establishing a means of directly communicating with the applicant about the loan. Through the use of the video and audio capabilities, the loan officer may be able to more quickly and efficiently evaluate the loan application and add or eliminate conditions for approval of the loan. In one embodiment, a video camera may also allow a loan officer to view the item being purchased, which may serve as collateral for the loan.

In some embodiments, it may be desirable to eliminate a camera or microphone from either the first computer or the second computer or both. For example, in an embodiment, a camera, but not microphone, is in communication with the first computer. Further, no camera or microphone is in communication with the second computer. Such an embodiment may be useful for providing a picture of the applicant to accompany the loan application and driver's license image. The photograph may be useful for ensuring the applicant is the same person as is shown on the driver's license. Further, the photograph may be useful for preventing identity theft.

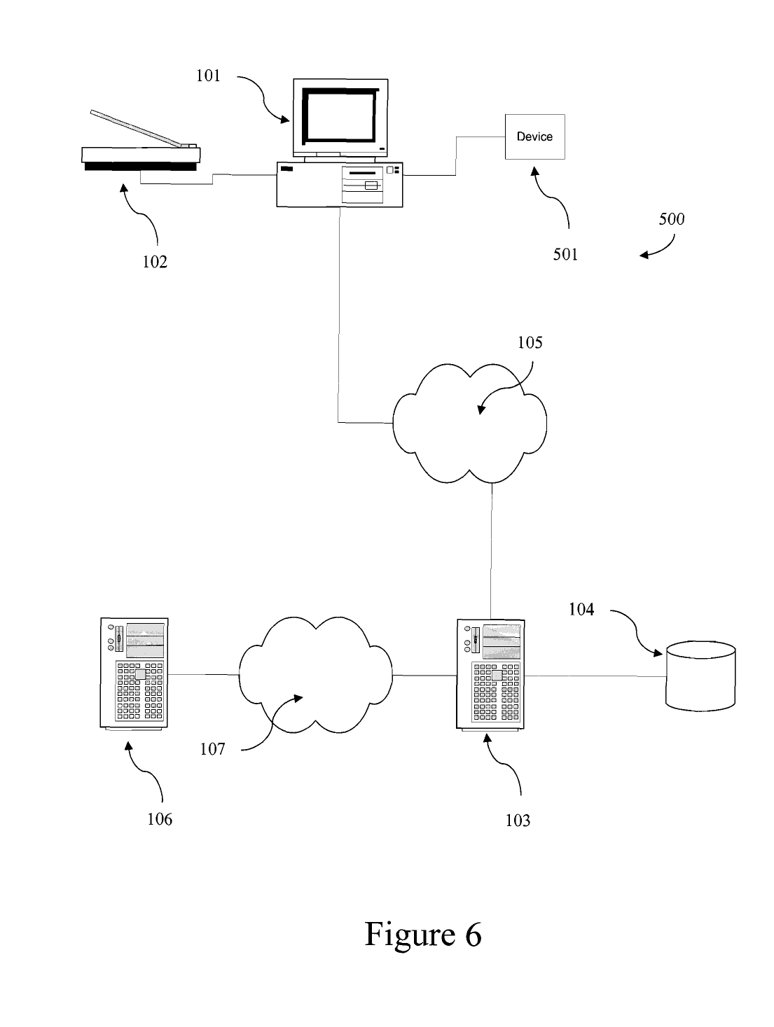

Referring now to FIG. 6, which is a block diagram illustrating a system for automated loan processing in one embodiment of the present invention. The system 500 comprises the elements as described with respect to FIG. 1, with the addition of device 501, which is in communication with the computer. The device 501 may comprise any of a number of authentication or identification devices. For example, device 501 may comprise a fingerprint scanner. A system comprising a thumbprint scanner may perform the method described with reference to FIGS. 2 and 3, but may add steps for scanning an applicant's thumbprint or fingerprint, storing an image of the thumbprint or fingerprint, and transmitting the image of the thumbprint or fingerprint to the server, where the image of the thumbprint or fingerprint may be stored in a database along with the application. Such a device 501 and method may provide the advantage of authentication of the identity of the applicant, or aid in the prevention of identity theft. In other embodiments, device 501 may comprise other forms of devices for receiving biometric data. In an embodiment, device 501 may comprise a retinal scanner. In other embodiments, device 501 may comprise an input device capable of receiving data wirelessly. For example, in an embodiment, device 501 may comprise a Bluetooth-enabled device configured to communicate with a personal digital assistant (PDA), cell phone, or other device

In other embodiments comprising devices capable of receiving biometric data, a scanner 102 may not be required. For example, in one embodiment, a device capable of reading biometric data may be in communication with the computer 101, which is further in communication with a database. The database may comprise records, including records comprising personal data and biometric data. The computer 101 may be configured to find personal data within the database based at least in part on the biometric data. For example, in one embodiment, a device maybe capable of receiving data relating to an applicants thumbprint. The computer 101 may then request personal data from the database associated with the thumbprint. In such an embodiment, it may not be necessary to scan a driver's license.

FIG. 7 is a screenshot of a sample user interface for automated loan processing in one embodiment of the present invention. In the embodiment shown in FIG. 7, the user interface comprises a main window, which comprises a series of interface elements including buttons, check boxes, input fields and display fields. The input fields comprise input fields for driver's license data 602 and applicant input data 603. In some embodiments, the driver's license data fields 602 are filled in automatically with data scanned from a driver's license. In other embodiments, some of the driver's license data fields 602 are filled in automatically with data scanned from a driver's license. In some embodiments, some or all of the applicant input data fields 603 may be automatically filled in with data, for example, using data from an online catalog. The display fields comprise fields for displaying the loan amount, which in some embodiments may be calculated based on at least the total cash price, the cash down payment and the net trade-in values, and messages relating to the status of the loan processing.

In the embodiment shown in FIG. 7, several check boxes are configured to receive input from an applicant. For example, check boxes 604 may correspond to the type of loan may be selected by selecting one of check boxes 604a, 604b, or 604c. Further, an applicant may select a check box 605 to indicate acceptance of the disclosure statements. In some embodiments, the applicant may be required to select a “Show Disclosure” button and read text comprising terms or conditions before selecting the check box 605 to indicate acceptance of the disclosure statements. In the embodiment shown in FIG. 7, selecting the check box for indicating acceptance of the disclosure terms may cause a window to be displayed comprising the disclosure terms associated with the loan application. The applicant may then be required to view the disclosure terms before accepting them. In other embodiments, the disclosure statements may not be displayed when an applicant attempts to select the checkbox corresponding to acceptance of the disclosure statements. In some embodiments, the submit button 609 may be deactivated until the applicant agrees to the disclosure statement or check box 605 has been selected.

The embodiment of the user interface shown in FIG. 7 comprises buttons that may be configured to receive applicant input. For example, an applicant may reset all of the driver's license data by pressing button 606, or all of the application data by pressing button 607. Further, an applicant may enable viewing or editing of application data relating to a co-applicant by pressing button 608. In some embodiments, some or all of the buttons shown in FIG. 7 may not be used. For example, if the application is only to be made by a single applicant, a button for a co-applicant may be disabled. User interfaces in embodiments of the present invention may comprise a button 609 to allow the applicant to submit the loan application for processing. In an embodiment, the button to submit the application may be disabled until the applicant has indicated acceptance of the disclosure statements.

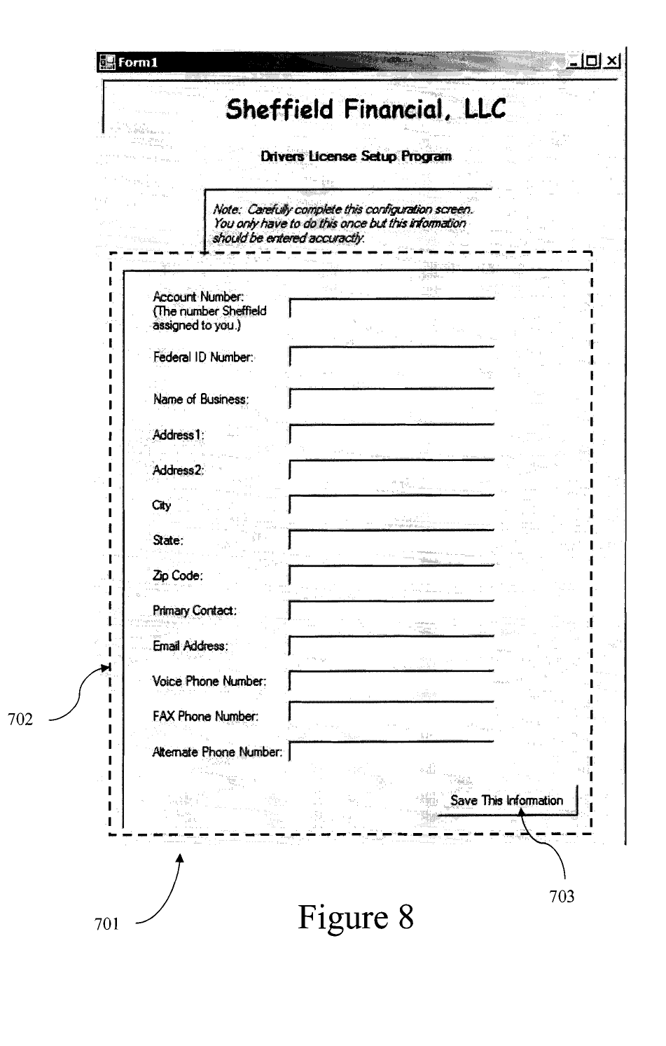

Embodiments of the present invention may be configured by a dealer or store owner who maintains and operates an embodiment of the present invention to allow its customers to apply for and receive loans at the point of purchase. FIG. 8 illustrates an embodiment of a user interface that may be displayed by the computer in some embodiments of the present invention. In some embodiments of the present invention, the user interface 600 may be provided as a convenient means for prompting for and receiving input from a loan application. For example, the user interface 600 may be configured to display fields of a loan application to an applicant, and to receive information from the applicant relating to the displayed fields. A user interface 600 may also be advantageous for displaying information to an applicant, such as disclosure statements, notices and/or terms of a loan. A user interface 600 in some embodiments of the invention may also allow an applicant to electronically submit a loan application to a financial institution, or to display feedback or information received from the financial institution relating to the loan application, such as status of the application or an approval or rejection of the application. The user interface 600 may further be configured to display other information to a loan applicant or other person interacting with an embodiment of the present invention, such as information relating to special offers or incentives.

In the embodiment shown in FIG. 8, the configuration interface 700 comprises a window 701, which comprises configuration fields 702 and a button 703 to save the data entered into the configuration fields. Using an embodiment of the present invention comprising the configuration interface 700, a dealer may configure the embodiment of the present invention to store information pertaining to the dealer by entering data into each of the configuration fields 702. The dealer may then press the button 703 to save the data to memory within the computer 101. Such configuration information, in one embodiment of the present invention, may then be included within a loan application transmitted to a financial institution,. Other embodiments of the present invention may comprise additional configuration fields or configuration screens. Some embodiments may comprise more than one screen, while some may comprise no screen. For example, in one embodiment, a financial institution may provide a pre-configured embodiment of the present invention such that no configuration is necessary by the dealer.

An example of an embodiment of the present invention comprises a kiosk located within a store. While not discussed in detail herein, such a kiosk could also be provided at other locations, such as the common areas at a shopping center. The kiosk comprises a computer and a card reader in communication with the computer. The computer comprises a processor in communication with a display, a keyboard and a mouse. The computer is in communication with a server at a bank.

A customer at the store may desire a loan in order to purchase an expensive item at the store. The customer may then enter the kiosk and insert his or her driver's license into the card reader. The card reader can then scan the customer's driver's license and transmit the scanned data to the computer. The computer may then store the scanned data in memory and perform OCR on the scanned data. Having recognized data from the scanned data, the computer may then display a user interface screen, such as the user interface screen shown in FIG. 7, in which data fields corresponding to data recognized from the scanned data are filled with the recognized data. The customer may then enter data into the remaining fields using the keyboard and the mouse. In addition, the computer may display a user interface button to allow the applicant to view a catalog of merchandise available for purchase within the store. For example, an applicant wishing to purchase a riding lawn mower may select the desired model within the catalog. The computer can then use data from the catalog to fill in additional fields within the user interface relating, for example, to purchase price.

In an embodiment of the present invention, a kiosk may further comprise a system for providing advertising information to an applicant. For example, a kiosk may comprise a television screen configured to display advertisements. In an embodiment of the present invention, a kiosk may comprise an audio system, including speakers, configured to play advertisements.

Once the applicant has entered sufficient data, the user interface may allow the applicant to view one or more disclosure statements. In the present embodiment, the disclosure statements may relate to statements granting permission to the bank to check the customer's credit. If the applicant agrees to the disclosure statements, the applicant may use the mouse to press a button to submit the application to the bank for evaluation.

Once the applicant presses the button to submit the data for evaluation, the computer encrypts the scanned data and the data entered into the fields in the application and transmits the encrypted files to the server. The computer then deletes the encrypted files from its memory.

After the computer has transmitted the encrypted data files, the server receives the encrypted data files. The server decrypts the data files and creates a viewable HTML file from the scanned data and the application data. The server then creates a TIFF file from the HTML file. The TIFF file is stored in the bank's database, while the data in the HTML file is processed by a bank employee. The data from the HTML file is entered into an electronic form maintained by the bank. Once the data has been transferred into the electronic form, the form is verified to ensure all data fields have been completed. Data from the form, such as social security number and name, are then automatically transmitted by the server to a credit bureau server in a request for a credit report. The server then receives a credit report from the credit bureau. The server then transmits the credit report and the loan application to a loan officer for evaluation.

Once the loan officer has received the loan application and the credit report, he or she will decide whether to approve or deny the loan. If the applicant's credit score is greater than a threshold, the loan officer will approve the loan. The loan officer will then cause the server to transmit the approval to the computer from which the applicant applied for the loan. Further, the loan officer will cause the server to transmit an authorization code to the computer. The applicant may then use the authorization code to purchase the lawn mower directly from the catalog displayed by the computer. Once the applicant has purchased the lawn mower with the authorization code, the applicant may then close the catalog and the loan application and exit the kiosk.

Variations of the embodiment described in the preceding example may be apparent to those of ordinary skill in the art. For example, in a variant of the embodiment described above, the server may be configured to receive data from the computer and automatically transfer the application data to an electronic application form for transmittal to a loan officer. Another variant of the preceding example may comprise a system capable of automatically approving a loan application with a credit score above a threshold. Other embodiments incorporating elements not herein described will be apparent to those of skill in the art.

Embodiments of the present invention may be stored as instructions, code or programs on computer-readable media. Systems in communication with such computer-readable media may execute the instructions stored within the computer-readable media to perform the steps described herein as carried out, or assisted, by a processor, computer or server. Embodiments of computer-readable media may comprise, but are not limited to, an electronic, optical, magnetic, or other storage or transmission device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other forms of computer-readable media may transmit or carry instructions to a computer, such as a router, private or public network, or other transmission device or channel. The processor, and the processing, described may be in one or more structures, and may be dispersed through one or more structures. The processor may comprise code for carrying out one or more of the methods (or parts of methods) described herein.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the this invention.

That which is claimed:

1. A method for providing an automated loan application, comprising:
scanning an applicant's identification card;
extracting applicant identity data from the identification card;
receiving additional data, wherein the additional data comprise an amount of money to be borrowed;
transmitting the applicant identity data and the additional data to a financial institution;
determining whether to lend the amount of money to the applicant based at least in part on the identity data and the additional data; and
notifying the applicant of whether the financial institution will lend money to the applicant.

2. The method of claim 1, wherein the additional data further comprises at least one of a social security number, a telephone number, or an indication of a type of loan.

3. The method of claim 1, wherein at least a portion of the additional data is provided by the applicant.

4. The method of claim 2, wherein the type of loan comprises one of a personal loan or a commercial loan.

5. The method of claim 1, wherein the identification card comprises a driver's license.

6. The method of claim 5, wherein extracting applicant identity data comprises extracting at least one of the applicant's name, applicant's address, applicant's date of birth, applicant's driver's license number, or an expiration date of applicant's driver's license.

7. The method of claim 5, wherein extracting applicant identity information comprises optical character recognition.

8. The method of claim 7, wherein extracting applicant identity information further comprises identifying at least one information field on the identification card.

9. The method of claim 8, further comprising extracting applicant identity information from the at least one information field and associating the extracted applicant identity information with a type of identity information.

10. The method of claim 1, wherein transmitting the applicant identity data and the additional data to a financial institution comprises transmitting an image of the applicant's identification card.

11. The method of claim 1, further comprising encrypting the applicant identity data and the additional data.

12. The method of claim 1, further comprising generating a loan agreement based on at least a portion of the applicant identity data and the additional data.

13. The method of claim 12, further comprising printing the loan agreement.

14. The method of claim 13, further comprising the applicant signing the loan agreement, scanning the loan agreement, and transmitting the scanned loan agreement to the financial institution.

15. The method of claim 12, further comprising receiving an electronic signature from the applicant.

16. The method of claim 1, wherein determining whether to lend an amount of money to the applicant is performed by an automated process.

17. The method of claim 16, wherein the automated process comprises:
electronically querying at least one credit bureau to obtain a credit score for the applicant;
comparing the credit score to a first credit score threshold and a second credit score threshold; and
approving the loan if the credit score is greater than the first credit score threshold, or denying the loan if the credit score is less than the second credit score threshold.

18. The method of claim 1, wherein determining whether to lend an amount of money to the applicant based at least in part on the identity data and the additional data is performed by the financial institution.

19. The method of claim 18, wherein the financial institution comprises a bank, a credit union, or a credit facility.

20. The method of claim 1, wherein the applicant is a first applicant, and further comprising:
scanning a second applicant's identification card,
extracting second applicant identity data, and
receiving second applicant additional data from the second applicant; and
wherein transmitting the applicant identity data and the additional information further comprises transmitting the second applicant identity data and the second applicant additional data to the financial institution.

21. The method of claim 20, wherein the second applicant is a co-signer on a loan to the first applicant.

22. The method of claim 1, further comprising:
receiving promotion information from the financial institution; and
displaying the promotion information to the applicant.

23. The method of claim 1, further comprising:
receiving promotion information from the financial institution; and
displaying the promotion information to a dealer.

24. A system for providing an automated loan application, comprising:
a local processor in communication with a scanner, the processor configured to:
receive scanned data from the scanner,
extract applicant identity data based at least in part on the scanned data,
receive additional data from an applicant,
transmit the applicant identity data and the additional data to a financial institution; and
a remote processor in communication with the local processor, the remote processor configured to:
receive the applicant identity data and the additional data, and
transmit a notification data to the local processor of whether the financial institution will lend money to the applicant.

25. The system of claim 24, wherein the remote processor is further configured to determine whether to lend an amount of money to the applicant based at least in part on the applicant identity data and the additional data.

26. The system of claim 24, wherein the remote processor is further configured to transmit the applicant identity data and the additional data to a third processor, and receive a notification from the third processor of whether the financial institution will lend money to the applicant.

27. The system of claim 24, further comprising at least one of a microphone, a speaker, or a camera.

28. The system of claim 27, wherein the local processor and the remote processor are configured to allow the applicant to interact with a representative of the financial institution using the microphone, the speaker, the camera, or a combination thereof.

29. The system of claim 24, wherein the local processor comprises one of a computer, a personal digital assistant, or a cell phone.

30. The system of claim 24, wherein the local processor is further configured to generate a sales invoice based at least in part on the applicant identity data and the additional data.

31. The system of claim 24, wherein the local processor is in communication with an electronic sales catalog, and the local processor is further configured to:
receive sales data from the electronic sales catalog, and transmit the sales data to the financial institution.

32. The system of claim 31, wherein the sales data comprises at least one of a price, an image, or a product number.

33. A computer-readable medium comprising program code, the program code comprising:
program code for scanning an applicant's identification card;
program code for extracting applicant identity data;
program code for receiving additional data, wherein the additional data comprise an amount of money to be borrowed;
program code for transmitting the applicant identity data and the additional data to a financial institution;
program code for determining whether to lend the amount of money to the applicant; and
program code for notifying the applicant of whether the financial institution will lend the amount of money to the applicant.

34. The computer-readable medium of claim 33, further comprising program code to receive data from the financial institution, the data comprising at least one of an update to the program code, an advertisement, a special offer, a promotion, or a reward.

35. The computer readable medium of claim 34, further comprising displaying the special offer, advertisement, promotion, or reward to the applicant.

36. The computer readable medium of claim 34, further comprising displaying the special offer, advertisement, promotion, or reward to a dealer.

37. The computer-readable medium of claim 36, wherein the reward comprises a monetary reward for the dealer if a first threshold number of loans is approved for the dealer's customers.

38. A method for providing an automated loan application, comprising:
scanning an applicant's driver's license;
storing data comprising applicant identity data from the applicant's driver's license;
identifying at least one information field within the stored data;
recognizing at least one piece of identity data from the at least one information field using optical character recognition;
receiving additional data from the applicant, the additional data comprising an amount of money to be borrowed;
displaying a disclosure statement;
receiving an acceptance of the disclosure statement from the applicant;
encrypting at least a portion of the stored data, the identity data, and the additional data;
transmitting the encrypted data to a financial institution;
decrypting the encrypted data;
determining whether to lend the amount of money to the applicant; and
notifying the applicant of the determination.

39. A computer-readable medium comprising program code, the program code comprising:
program code for scanning an image of an applicant's driver's license, the first side comprising applicant identity data;
program code for extracting at least one information field within the image;
program code for recognizing at least one piece of identity data from the at least one information field using optical character recognition;
program code for receiving additional data, the additional data comprising an amount of money to be borrowed;
program code for displaying a disclosure statement;
program code for receiving an acceptance of the disclosure statement from the applicant;
program code for encrypting the image, the identity data, and the additional data;
program code for transmitting the image, the identity data, and the additional data to a financial institution;
program code for decrypting the image, the identity data, and the additional data;
program code for determining whether to lend the amount of money to the applicant; and
program code for notifying the applicant of whether the financial institution will lend the amount of money to the applicant.
